(19) United States
(12) Patent Application Publication
(10) Pub. No.: US 2022/0189404 A1
(43) Pub. Date: Jun. 16, 2022

(54) GOA CIRCUIT AND DISPLAY PANEL

(71) Applicant: Shenzhen China Star Optoelectronics Semiconductor Display Technology Co., LTD., Shenzhen, Guangdong (CN)

(72) Inventor: Xiaobin HU, Shenzhen, Guangdong (CN)

(21) Appl. No.: 17/055,345

(22) PCT Filed: Jul. 10, 2020
(86) PCT No.: PCT/CN2020/101359

§ 371 Date: Nov. 13, 2020

(30) Foreign Application Priority Data
Jun. 9, 2020 (CN) 202010517010.8

(51) Int. Cl. G09G 3/3266

(52) U.S. Cl. CPC G09G 3/3266; G09G 2320/045; G09G 2300/0408; G09G 2310/08

(57) ABSTRACT

A GOA circuit and a display panel are provided. The GOA circuit and the display panel decrease thin film transistors required by an inverter in a circuit structure. A thin film transistor number is decreased, and an area occupied by a GOA space can be effectively decreased, which facilitates decreasing of border sizes of panels. Gates of thin film transistors of the GOA circuit are controlled by clock signals that have not been attenuated, which can prevent failure resulting from an attenuated cascaded signal caused by threshold voltage drifting of thin film transistors.

### FIELD OF INVENTION

The present invention relates to the field of display technology, and especially to a gate driver on array (GOA) circuit and a display panel.

### BACKGROUND OF INVENTION

Gate driver on array (GOA) technology is advantageous to a narrow-border display screen design and decreases costs. It has extensive researches and wide applications.

### SUMMARY OF INVENTION

FIG. 1 is a general single stage GOA circuit. FIG. 2 is a timing diagram of the GOA circuit. In the GOA circuit, a threshold voltage of thin film transistors drifts after operating for a long time, which leads to attenuation of output signals ST(N), Q(N), and G(N). Wherein, a conducting state and a turn-off state of thin film transistors having gates controlled by attenuated signals (such as T11, T31, T41, T25, T52, and T54 in FIG. 1) will further deteriorate, which leads to further attenuation of the output signals. Such kind of unstable state will be reduced to a vicious circle, leading to a failure of the GOA circuit. In order to increase reliability of the circuit, an inverter consisting of thin film transistors in FIG. 1 (T51, T52, T53, T54) and a node voltage will be added to maintain thin film transistor T42, T26, and T32. However, on the one hand, this approach increases many thin film transistors, resulting in a larger area occupied by the GOA circuit and a wider border of the panel. On the other, gates of T52 and T54 of the inverter are also controlled by an attenuated signal Q(N), and a vicious circle results from electric potential competition of node KN and node Q(N) in FIG. 1 still exists, which easily leads to a failure.

The present invention is to provide a GOA circuit that decreases a thin film transistor number of the GOA circuit and increases stability of the GOA circuit as well.

The present invention provides a GOA circuit that includes a plurality of cascaded GOA circuit units, wherein an n-stage GOA circuit unit includes a pull-up control circuit unit 101, a pull-up circuit unit 102, a transfer circuit unit 103, a pull-down circuit unit 104, and a capacitor Cb; wherein the pull-up control circuit unit 101, the pull-up circuit unit 102, the transfer circuit unit 103, the pull-down circuit unit 104, a pull-down maintenance circuit unit 105, and the capacitor Cb are all electrically connected to a first node Q(n); the pull-up circuit unit 101 receives a clock signal CKN−1 of an (n−1)-stage GOA circuit unit, and a start trigger signal STV or a cascaded signal STN−1 of the (n−1)-stage GOA circuit unit to charge the first node Q(n) to a high electric potential; the pull-up circuit unit 102 receives a clock signal CKN to pull up an output signal GN of the n-stage GOA circuit unit to a high electric potential of the clock signal CKN; the transfer circuit unit 103 receives the clock signal CKN and outputs a cascaded signal STN of the n-stage GOA circuit unit to control a pull-up control circuit unit of an (n+1)-stage GOA unit to turn on or turn off; the pull-down circuit unit 104 receives a clock signal CKN+2 of an (n+2)-stage GOA circuit unit, a first low-electric-potential direct current signal VSSQ, and a second low-electric-potential direct current signal VSSG to pull down a precharge electric potential of the first node Q(n), an electric potential of the cascaded signal STN of the n-stage GOA circuit unit, and an electric potential of the n-stage scan driving signal G(n) to a low electric potential; and the capacitor Cb is configured to provide and maintain the precharge electric potential of the first node Q(n), and the capacitor Cb is connected to the output signal GN of the n-stage GOA circuit unit.

Furthermore, the pull-up control circuit unit 101 includes:

A first thin film transistor T11, wherein a gate of the first thin film transistor T11 is connected to the clock signal CKN−1 of the (n−1)-stage GOA circuit unit, a drain of the first thin film transistor T11 is connected to the start trigger signal STV or the cascaded signal STN−1 of the (n−1)-stage GOA circuit unit, and a source of the first thin film transistor T11 is connected to the first node QN.

Furthermore, the pull-up circuit unit 102 includes:

A second thin film transistor T21, wherein a gate of the second thin film transistor T21 is connected to the first node QN, a drain of the second thin film transistor T21 is connected to the clock signal CKN, and a source of the second thin film transistor T21 is connected to the output signal GN of the n-stage GOA circuit unit.

Furthermore, the transfer circuit unit 103 includes:

A third thin film transistor T22, wherein a gate of the third thin film transistor T22 is connected to the first node QN, a drain of the third thin film transistor T22 is connected to the clock signal CKN, and a source of the third thin film transistor T22 outputs the cascaded signal STN of the n-stage GOA circuit unit.

Furthermore, the pull-down circuit unit 104 includes:

A fourth thin film transistor T23, wherein a gate of the fourth thin film transistor T23 is connected to the clock signal CKN+2 of the (n+2)-stage GOA circuit unit, a drain of the fourth thin film transistor T23 is connected to the cascaded signal STN of the n-stage GOA circuit unit, and a source of the fourth thin film transistor T23 is connected to the first low-electric-potential direct current signal VSSQ;

A fifth thin film transistor T31, wherein a gate of the fifth thin film transistor T31 is connected to the clock signal CKN+2 of the (n+2)-stage GOA circuit unit, a drain of the fifth thin film transistor T31 is connected to the output signal GN of the n-stage GOA circuit unit, and a source of the fifth thin film transistor T31 is connected to the second low-electric-potential direct current signal VSSG; and

A sixth thin film transistor T41, wherein a gate of the sixth thin film transistor T41 is connected to the clock signal CKN+2 of the (n+2)-stage GOA circuit unit, a drain of the sixth thin film transistor T41 is connected to the first node QN, and a source of the sixth thin film transistor T41 is connected to the first low-electric-potential direct current signal VSSQ.

Furthermore, if n is equal to 1, then the drain of the first thin film transistor T11 is connected to the start trigger signal STV;

If n is greater than 1, then the drain of the first thin film transistor T11 is connected to the cascaded signal STN−1 of the (n−1)-stage GOA circuit unit.

Furthermore, duty ratios of high electric potential of the clock signals CKN−1, CKN, CKN+1, and CKN+2 are 25%, the clock signals sequentially delay, and a delay time between adjacent clock signals is 25% of a clock cycle time; the high electric potential of the clock signals is identical to a high electric potential of the start trigger signal STV; and a low electric potential of the clock signals is identical to a low electric potential of the start trigger signal STV.

Furthermore, an electric potential of the first low-electric-potential direct current signal VSSQ is identical to a low electric potential of the start trigger signal STV; and an electric potential of the second low-electric-potential direct current signal VSSG is greater than the electric potential of the first low-electric-potential direct current signal VSSQ.

Furthermore, the GOA circuit includes phase 1 to phase 5 in one period;

In phase 1, the start trigger signal STV rises, and the circuit is activated;

In phase 2, the clock signal CKN−1 and the cascaded signal STN−1 of the (n−1)-stage GOA circuit unit are simultaneously at the high electric potential, while CKN+2 is at the low electric potential, T41, T31, and T23 are turned off, and therefore the first node QN of a current stage is charged to the high electric potential, thereby turning on transistors T21 and T22;

In phase 3, the clock signal CKN−1 is at the low electric potential to turn off T11, and simultaneously the clock signal CKN changes into the high electric potential to charge output signals STN and GN to the high electric potential, wherein the output signal GN is configured to drive a current row load of a panel (driving of gate lines), and the output signal STN is cascaded to a next stage (cascaded signal) to charge a first node QN+1 of the next stage to the high electric potential;

In phase 4, the clock signal CKN changes into the low electric potential and pulls down the output signals STN and GN to the low electric potential; and

In phase 5, the clock signal CKN+2 is at the high electric potential to turn on T41, and to pull the first node QN to the low electric potential, thereby turning off transistors T21 and T22.

The present invention further provides a display panel that includes the GOA circuit.

The present invention provides a GOA circuit and a display panel that decrease thin film transistors required by an inverter in a circuit structure. A thin film transistor number is decreased, and an area occupied by a GOA space can be effectively decreased, which facilitates decreasing of border sizes of panels. Gates of thin film transistors of the GOA circuit are controlled by clock signals that have not been attenuated, which can prevent failure resulting from an attenuated cascaded signal caused by threshold voltage drifting of thin film transistors.

### DESCRIPTION OF DRAWINGS

FIG. 1 is a circuit diagram of a gate driver on array (GOA) circuit of conventional technology.

FIG. 2 is a waveform of timing control and signal output of the GOA circuit of conventional technology.

FIG. 3 is a circuit diagram of a GOA circuit according to the present invention.

FIG. 4 is a waveform of timing control and signal output of the GOA circuit according to the present invention.

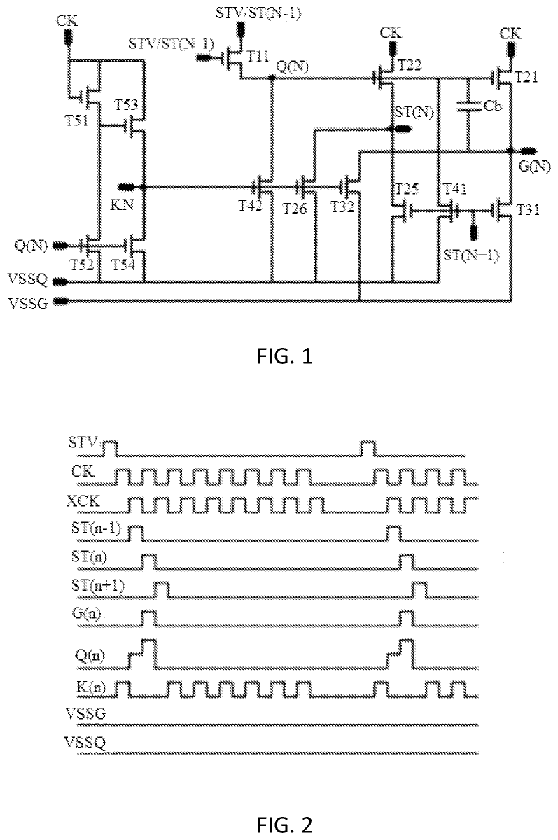

### DETAILED DESCRIPTION OF PREFERRED EMBODIMENTS

In order to make a purpose, technical approach, and effect of the present application more clear and definite, the following describes the present application in detail using embodiments with reference to accompanying drawings. It should be understood that specific embodiments described here are merely used to explain the present application and not intended to limit the present application.

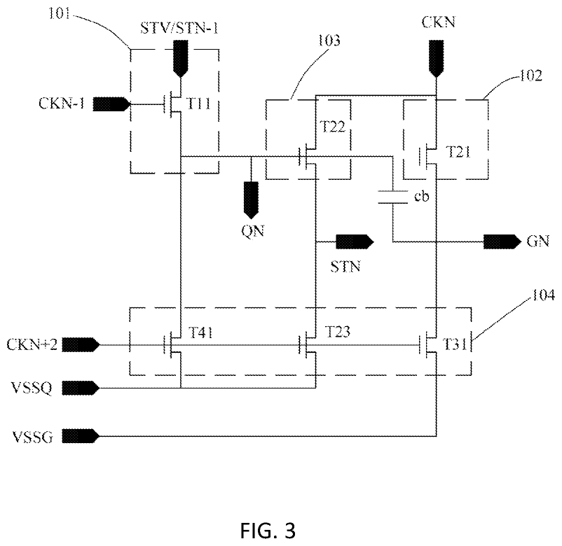

As shown in FIG. 3, the present invention provides a gate driver on array (GOA) circuit that includes a plurality of cascaded GOA circuits.

Wherein, an n-stage GOA circuit unit includes a pull-up control circuit unit 101, a pull-up circuit unit 102, a transfer circuit unit 103, a pull-down circuit unit 104, and a capacitor Cb.

The pull-up control circuit unit 101, the pull-up circuit unit 102, the transfer circuit unit 103, the pull-down circuit unit 104, a pull-down maintenance circuit unit 105, and the capacitor Cb are all electrically connected to a first node Q(n).

The pull-up circuit unit 101 receives a clock signal CKN−1 of an (n−1)-stage GOA circuit unit, and a start trigger signal STV or a cascaded signal STN−1 of the (n−1)-stage GOA circuit unit, to charge the first node Q(n) in the circuit to a high electric potential.

The pull-up control circuit unit 101 includes a first thin film transistor T11, wherein a gate of the first thin film transistor T11 is connected to the clock signal CKN−1 of the (n−1)-stage GOA circuit unit, a drain of the first thin film transistor T11 is connected to the start trigger signal STV or the cascaded signal STN−1 of the (n−1)-stage GOA circuit unit, and a source of the first thin film transistor T11 is connected to the first node QN.

The pull-up circuit unit 102 receives a clock signal CKN to pull up an output signal GN of the n-stage GOA circuit unit to a high electric potential of the clock signal CKN.

The pull-up circuit unit 102 includes a second thin film transistor T21, wherein a gate of the second thin film transistor T21 is connected to the first node QN, a drain of the second thin film transistor T21 is connected to the clock signal CKN, and a source of the second thin film transistor T21 is connected to the output signal GN of the n-stage GOA circuit unit.

The transfer circuit unit 103 receives the clock signal CKN and outputs a cascaded signal STN of the n-stage GOA circuit unit, to control turning on or turning off of a pull-up control circuit unit of an (n+1)-stage GOA unit.

The transfer circuit unit 103 includes:

A third thin film transistor T22, wherein a gate of the third thin film transistor T22 is connected to the first node QN, a drain of the third thin film transistor T22 is connected to the clock signal CKN, and a source of the third thin film transistor T22 outputs the cascaded signal STN of the n-stage GOA circuit unit.

The pull-down circuit unit 104 receives a clock signal CKN+2 of an (n+2)-stage GOA circuit unit, a first low-electric-potential direct current signal VSSQ, and a second low-electric-potential direct current signal VSSG, to pull down precharge of the first node Q(n), and pull down electric potential of the cascaded signal STN of the n-stage GOA circuit unit and of the n-stage scan driving signal G(n) to a low electric potential.

The pull-down circuit unit 104 includes:

A fourth thin film transistor T23, wherein a gate of the fourth thin film transistor T23 is connected to the clock signal CKN+2 of the (n+2)-stage GOA circuit unit, a drain of the fourth thin film transistor T23 is connected to the cascaded signal STN of the n-stage GOA circuit unit, and a source of the fourth thin film transistor T23 is connected to the first low-electric-potential direct current signal VSSQ;

A fifth thin film transistor T31, wherein a gate of the fifth thin film transistor T31 is connected to the clock signal CKN+2 of the (n+2)-stage GOA circuit unit, a drain of the fifth thin film transistor T31 is connected to the output signal GN of the n-stage GOA circuit unit, and a source of the fifth thin film transistor T31 is connected to the second low-electric-potential direct current signal VSSG; and

A sixth thin film transistor T41, wherein a gate of the sixth thin film transistor T41 is connected to the clock signal CKN+2 of the (n+2)-stage GOA circuit unit, a drain of the sixth thin film transistor T41 is connected to the first node QN, and a source of the sixth thin film transistor T41 is connected to the first low-electric-potential direct current signal VSSQ.

The capacitor Cb is configured to provide and maintain a precharge electric potential of the first node Q(n), and the capacitor Cb is connected to the output signal GN of the n-stage GOA circuit unit.

Furthermore, if n is equal to 1, then the drain of the first thin film transistor T11 is connected to the start trigger signal STV; if n is greater than 1, then the drain of the first thin film transistor T11 is connected to the cascaded signal STN−1 of the (n−1)-stage GOA circuit unit.

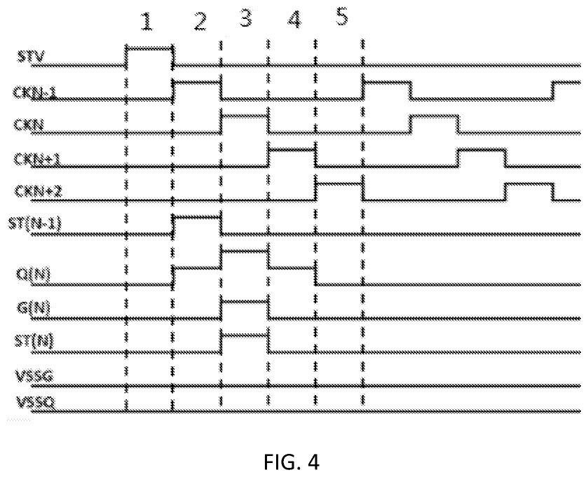

FIG. 4 is a timing control diagram according to the present invention. Wherein, duty ratios of high electric potential of the clock signals CKN−1, CKN, CKN+1, and CKN+2 are 25%. The clock signals sequentially delay, and a delay time between adjacent clock signals is 25% of a clock cycle time.

The high electric potential of the clock signals is identical to a high electric potential of the start trigger signal STV, and a low electric potential of the clock signals is identical to a low electric potential of the start trigger signal STV.

An electric potential of the first low-electric-potential direct current signal VSSQ is identical to a low electric potential of the start trigger signal STV, and an electric potential of the second low-electric-potential direct current signal VSSG is greater than the electric potential of the first low-electric-potential direct current signal VSSQ.

Referring again to FIG. 2, in one period, in phase 1, the start trigger signal STV rises, and the circuit is activated; in phase 2, the clock signal CKN−1 and the cascaded signal STN−1 of the (n−1)-stage GOA circuit unit are simultaneously at the high electric potential, while CKN+2 is at the low electric potential, T41, T31, and T23 are turned off, and therefore the first node QN of a current stage is charged to the high electric potential, thereby turning on transistors T21 and T22; in phase 3, the clock signal CKN−1 is at the low electric potential and turns off T11, and simultaneously the clock signal CKN changes into the high electric potential and charges output signals STN and GN to the high electric potential, wherein the output signal GN is configured to drive a current row load of a panel (driving of gate lines), and the output signal STN is cascaded to a next stage (cascaded signal) to charge a first node QN+1 of the next stage to the high electric potential; in phase 4, the clock signal CKN changes into the low electric potential and pulls down the output signals STN and GN to the low electric potential; and in phase 5, the clock signal CKN+2 is at the high electric potential, turns on T41, and pulls the first node QN to the low electric potential, thereby turning off transistors T21 and T22.

Afterward, in each period, the clock signal CKN+2 turns on T31, T41, and T23 once, and maintains GN, QN, and STN at a corresponding low electric potential, thereby contributing to a pull-down maintenance effect.

The present invention provides a GOA circuit that decreases thin film transistors required by an inverter in a circuit structure. A thin film transistor number is decreased, and an area occupied by a GOA space can be effectively decreased, which facilitates decreasing of border sizes of panels. Gates of thin film transistors of the GOA circuit are controlled by clock signals that have not been attenuated, which can prevent failure resulting from an attenuated cascaded signal caused by threshold voltage drifting of thin film transistors.

The GOA circuit is for a low temperature poly-silicon (LTPS) panel or for an organic light-emitting diode (OLED) panel.

The first to twelfth thin film transistors are all p-channel thin film transistors or all n-channel thin film transistors.

The present invention further provides a display panel that includes the above-mentioned GOA circuit. The display panel includes an OLED display panel or a LTPS display panel.

On the one hand, the GOA circuit decreases thin film transistors required by an inverter in a circuit structure. A number of the thin film transistors is decreased, and an area occupied by a GOA space can be effectively decreased, which facilitates decreasing of border sizes of panels, and facilitates realizing of narrow border designs of the display panel.

On the other hand, gates of thin film transistors of the GOA circuit are controlled by clock signals that have not been attenuated, which can prevent failure resulting from an attenuated cascaded signal caused by threshold voltage drifting of thin film transistors, thereby increasing reliability of the display panel.

It can be understood that a person of ordinary skill in the art can make equivalent alternations or changes according to technical approaches of the present application and the invention spirit, and all the changes or alternations are within the protection scope of the appended claims of the present application.

What is claimed is:

1. A gate driver on array (GOA) circuit, comprising a plurality of cascaded GOA circuit units, wherein an n-stage GOA circuit unit comprises a pull-up control circuit unit 101, a pull-up circuit unit 102, a transfer circuit unit 103, a pull-down circuit unit 104, and a capacitor Cb;
wherein the pull-up control circuit unit 101, the pull-up circuit unit 102, the transfer circuit unit 103, the pull-down circuit unit 104, a pull-down maintenance circuit unit 105, and the capacitor Cb are all electrically connected to a first node Q(n);
the pull-up circuit unit 101 receives a clock signal CKN−1 of an (n−1)-stage GOA circuit unit, and a start trigger signal STV or a cascaded signal STN−1 of the (n−1)-stage GOA circuit unit to charge the first node Q(n) to a high electric potential;
the pull-up circuit unit 102 receives a clock signal CKN to pull up an output signal GN of the n-stage GOA circuit unit to a high electric potential of the clock signal CKN;
the transfer circuit unit 103 receives the clock signal CKN and outputs a cascaded signal STN of the n-stage GOA circuit unit to control a pull-up control circuit unit of an (n+1)-stage GOA unit to turn on or turn off;
the pull-down circuit unit 104 receives a clock signal CKN+2 of an (n+2)-stage GOA circuit unit, a first low-electric-potential direct current signal VSSQ, and a second low-electric-potential direct current signal VSSG to pull down a precharge electric potential of the first node Q(n), an electric potential of the cascaded signal STN of the n-stage GOA circuit unit, and an electric potential of the n-stage scan driving signal G(n) to a low electric potential; and
the capacitor Cb is configured to provide and maintain the precharge electric potential of the first node Q(n), and the capacitor Cb is connected to the output signal GN of the n-stage GOA circuit unit.

2. The GOA circuit as claimed in claim 1, wherein the pull-up control circuit unit 101 comprises:
a first thin film transistor T11, wherein a gate of the first thin film transistor T11 is connected to the clock signal CKN−1 of the (n−1)-stage GOA circuit unit, a drain of the first thin film transistor T11 is connected to the start trigger signal STV or the cascaded signal STN−1 of the (n−1)-stage GOA circuit unit, and a source of the first thin film transistor T11 is connected to the first node QN.

3. The GOA circuit as claimed in claim 1, wherein the pull-up circuit unit 102 comprises:
a second thin film transistor T21, wherein a gate of the second thin film transistor T21 is connected to the first node QN, a drain of the second thin film transistor T21 is connected to the clock signal CKN, and a source of the second thin film transistor T21 is connected to the output signal GN of the n-stage GOA circuit unit.

4. The GOA circuit as claimed in claim 1, wherein the transfer circuit unit 103 comprises:
a third thin film transistor T22, wherein a gate of the third thin film transistor T22 is connected to the first node QN, a drain of the third thin film transistor T22 is connected to the clock signal CKN, and a source of the third thin film transistor T22 outputs the cascaded signal STN of the n-stage GOA circuit unit.

5. The GOA circuit as claimed in claim 1, wherein the pull-down circuit unit 104 comprises:
a fourth thin film transistor T23, wherein a gate of the fourth thin film transistor T23 is connected to the clock signal CKN+2 of the (n+2)-stage GOA circuit unit, a drain of the fourth thin film transistor T23 is connected to the cascaded signal STN of the n-stage GOA circuit unit, and a source of the fourth thin film transistor T23 is connected to the first low-electric-potential direct current signal VSSQ;
a fifth thin film transistor T31, wherein a gate of the fifth thin film transistor T31 is connected to the clock signal CKN+2 of the (n+2)-stage GOA circuit unit, a drain of the fifth thin film transistor T31 is connected to the output signal GN of the n-stage GOA circuit unit, and a source of the fifth thin film transistor T31 is connected to the second low-electric-potential direct current signal VSSG; and
a sixth thin film transistor T41, wherein a gate of the sixth thin film transistor T41 is connected to the clock signal CKN+2 of the (n+2)-stage GOA circuit unit, a drain of the sixth thin film transistor T41 is connected to the first node QN, and a source of the sixth thin film transistor T41 is connected to the first low-electric-potential direct current signal VSSQ.

6. The GOA circuit as claimed in claim 2, wherein if n is equal to 1, then the drain of the first thin film transistor T11 is connected to the start trigger signal STV; if n is greater than 1, then the drain of the first thin film transistor T11 is connected to the cascaded signal STN−1 of the (n−1)-stage GOA circuit unit.

7. The GOA circuit as claimed in claim 1, wherein
duty ratios of high electric potential of the clock signals CKN−1, CKN, CKN+1, and CKN+2 are 25%, the clock signals sequentially delay, and a delay time between adjacent clock signals is 25% of a clock cycle time;
the high electric potential of the clock signals is identical to a high electric potential of the start trigger signal STV; and
a low electric potential of the clock signals is identical to a low electric potential of the start trigger signal STV.

8. The GOA circuit as claimed in claim 1, wherein
an electric potential of the first low-electric-potential direct current signal VSSQ is identical to a low electric potential of the start trigger signal STV; and
an electric potential of the second low-electric-potential direct current signal VSSG is greater than the electric potential of the first low-electric-potential direct current signal VSSQ.

9. The GOA circuit as claimed in claim 1, wherein the GOA circuit comprises phase 1 to phase 5 in one period;
in phase 1, the start trigger signal STV rises, and the circuit is activated;
in phase 2, the clock signal CKN−1 and the cascaded signal STN−1 of the (n−1)-stage GOA circuit unit are simultaneously at the high electric potential, while CKN+2 is at the low electric potential, a sixth thin film transistor T41, a fifth thin film transistor T31, and a fourth thin film transistor T23 are turned off, and therefore the first node QN of a current stage is charged to the high electric potential, thereby turning on a second thin film transistor T21 and a third thin film transistor T22;
in phase 3, the clock signal CKN−1 is at the low electric potential to turn off T11, and simultaneously the clock signal CKN changes into the high electric potential to charge output signals STN and GN to the high electric potential, wherein the output signal GN is configured to drive a current row load of a panel (driving of gate lines), and the output signal STN is cascaded to a next stage (cascaded signal) to charge a first node QN+1 of the next stage to the high electric potential;
in phase 4, the clock signal CKN changes into the low electric potential and pulls down the output signals STN and GN to the low electric potential; and
in phase 5, the clock signal CKN+2 is at the high electric potential to turn on the sixth thin film transistor T41, and to pull the first node QN to the low electric potential, thereby turning off the second thin film transistor T21 and the third thin film transistor T22.

10. A display panel, comprising the GOA circuit as claimed in claim 1.
